(19) United States
(12) Patent Application Publication
(10) Pub. No.: US 2003/0010439 A1
(43) Pub. Date: Jan. 16, 2003

(54) Seam sealing apparatus and process therefor

(76) Inventor: Jay Thomas Fenton, Bear, DE (US)

Correspondence Address: E. Alan Uebler, Esq., E. Alan Uebler, P.A., 1601 Milltown Road, Suite 4, Wilmington, DE, 19808, US

(21) Appl. No.: 09/906,165

(22) Filed: Jul. 16, 2001

(51) Int. Cl. B65C 1/00; B29C 65/00

(52) U.S. Cl. 156/304.3; 156/578; 156/324

(57) ABSTRACT

Apparatus and a method for sealing of protective barrier fabric seams in otherwise impermeable articles such as garments, footwear, surgical gowns and the like, are provided, the sealed seams maintaining the imperviousness of the article, including seamed joints, to water, body fluids, pathogens and chemicals. In one pass through the apparatus, a sealed seam in a protective barrier fabric joint, using a curable adhesive sealant, is provided along a predetermined and specified length of the joint. The preferred adhesive is a silicone, most preferably a two-part, thermosetting silicone elastomeric adhesive. Also provided are mixing dies for use, inter alia, in the process which are especially suited for applying the two-part adhesive sealant. In addition, variable-residence-time curing apparatus, which effects variable, controlled, desired cures of the adhesive, all in a one-pass operation, is provided, together with precise metering pumps, especially suited for supplying the seam sealing adhesives in the process of the invention.

### BACKGROUND OF THE INVENTION

1. Field of the Invention

This invention relates to a process and apparatus for sealing seams in protective barrier fabrics, such as those found in waterproof garments and the like, to preserve the imperviousness of such fabrics at the seamed joints thereof, at which joints intersecting panels or sections of cloth are stitched together. The stitching creates holes through the garments at such joints, which holes must be sealed if the integrity of the garment as a fluid barrier throughout its construction is to be maintained.

2. Description of Related Art

Sealing of seams in protective garments and the like, at the stitched joints where intersecting panels of cloth are joined together, is known. Typically a tape of material, which may or may not be of the same material as the protective barrier fabric, and having a sealing adhesive applied to one side, is adhesively affixed to the garment overlaying and sealing the seam(s) along each joint of the garment. Known adhesives include thermoplastic and hot-melt urethane adhesives, certain glues, and, more recently, in co-pending application U.S. Ser. No. 09/414,879, filed Oct. 8, 1999, a silicone adhesive is disclosed which is suitable for this purpose. That application and this application are commonly assigned, and the disclosures of the pending application are incorporated here by reference thereto.

Protective items which employ seam seals include waterproof garments such as rainwear and tents for outdoor activities. Operating room gowns are sealed to protect the wearer from blood borne pathogens and other body fluids. Firemen's coats must offer complete protection from a variety of possible penetrants, including water, pathogens and a wide range of various chemicals which could be encountered in any given fire emergency situation.

Seam seals also often must withstand hostile environmental conditions. For example, firefighters' turnout gear, including the seams, must withstand high temperatures without melting. In seams in surgical protective garments, it is desirable that the seals be autoclave-sterilized numerous times, while retaining their barrier properties.

Generally, protective garments can be made to include a special protective barrier layer and other coverings or carrier layers, such as backings or facing fabrics. In these garments, the protective barrier layer protects the wearer from a threat to well being, such as rain, snow, chemicals, viruses or blood pathogens. Examples of such barrier layers include microporous polytetrafluoroethylene membranes, microporous or monolithic polyurethane membranes, and polyetherpolyester membranes. The protective barrier layers may be attached to or laminated to one or more layers of an abrasion resistant, high strength backing, usually a woven or knit fabric layer, to form a composite protective barrier fabric. Nylon and polyester backing fabrics are typical.

Garments may be assembled from these fabrics by sewing panels of the protective barrier fabric into the desired garment shape. Joints between the panels and other disruptions of the barrier layer must be sealed to provide a barrier function comparable to the protective barrier fabric itself. This generally is accomplished by applying a tape over the seam, as discussed above.

The process of seam sealing of protective barrier garments with a preferred silicone sealing adhesive generally includes applying liquid, uncross-linked silicone to the sealing tape backer, followed by consolidating the sealant covered backer tape over the seam and curing the polymer under heat and pressure in an extended, heated nip. The extended nip may include a soft surface roller opposing a hard, heated roller. The soft surface provides a mold-like restraint to maintain the uncross-linked silicone prepolymer in position until it is partially cured and cross-linked. Alternatively, as disclosed in the aforementioned copending application, an extended nip, in which the liquid adhesive is partially cured under heat and pressure, may be formed by a belt system in which a belt, tensioned by a belt-tensioner, which exerts pressure against a cooperatively functioning hot roller, is used, through which is passed the seamed joint overlaid by the tape containing adhesive thereon, thereby forming a sealed joint.

In addition, my prior U.S. Pat. No. 6,032,714, and the references cited therein, disclose various processes and apparatus used in seam sealing, and are illustrative of the present state of this art.

In contrast to the known prior art, the present invention provides a process and apparatus for completely sealing, in situ, a seamed joint in a protective barrier fabric, the sealing being effected with a tape containing a curable adhesive thereon, preferably a two-part silicone adhesive, in a one-pass operation. An adhesive application die especially suited for the seam sealing process is also provided, as is a pump system especially suited to supplying the two-part adhesive to this process.

### SUMMARY OF THE INVENTION

Apparatus and a method for sealing seams in protective barrier fabrics such as those found in waterproof garments and the like are provided. Sealing is accomplished by, in one continuous operation, feeding the seamed joint of a protective barrier fabric along its length to and through a consolidation nip, simultaneously feeding and guiding a backing tape to and through the nip adjacent the seamed joint, applying at a metered rate a curable sealing adhesive along a length of the tape just prior to entry of the tape into the nip, the adhesive being applied to that surface of the tape facing the seamed joint, and consolidating the tape with applied sealing adhesive thereon and the seamed joint in the nip while guiding the tape such that it lies along the length of and covers the seam, acting as a bridge thereover, with the sealing adhesive contacting the joint. During passage through the nip, the adhesive is cured by applied heat and pressure, the tape is then cut to a specified length while, simultaneously, stopping application of the sealing adhesive, thereby completing sealing the seam to the desired length along the seamed joint. The adhesive preferably is a silicone adhesive, which may be a two-part adhesive, and most preferred is a two-part, thermosetting silicone adhesive.

The consolidation nip is formed between a first member, being a roller member, and a second, co-acting, nip-forming member, which may be a roller, and wherein the spacing distance between the first member and the second, co-acting member is adjustable. The second, nip-forming roller may have a compressible surface thereof.

Alternatively, the second, nip-forming member may be an endless belt, which may be made of an elastic material. The first roller member and the second belt member are preferably adjustable in space, one with respect to the other, so as to permit variation and preset adjustability of the contact distance of the belt circumferentially along the first roller and within the nip. The belt is adjusted with respect to the first roller to effect a preset contact distance therebetween, that distance preferably being from about 0.5 inch to about 6 inches.

Tension may be applied to the endless belt in order to apply compressive pressure within the nip and between the tape and the joint.

The first roller may be heated and the feeding and guiding of the backing tape are preferably effected by non-contact means, such as by using air knives or applied vacuum means.

The jointed, seamed protective barrier fabric to be sealed may comprise a laminate of a backing fabric and a layer of microporous material such as microporous polytetrafluoroethylene, microporous polypropylene, microporous polyurethane and microporous polyetherpolyester, with porous, expanded polytetrafluoroethylene being preferred.

The backing tape may be a composite tape comprising a laminate of a backing fabric and a layer of a microporous material, such as microporous polytetrafluoroethylene, microporous polypropylene, microporous polyurethane and microporous polyetherpolyester, with porous, expanded polytetrafluoroethylene being preferred. The most preferred construction is one wherein said protective barrier fabric is a laminate of a backing fabric and a layer of porous, expanded polytetrafluoroethylene, and wherein the backing tape is a composite tape of a laminate of a backing fabric and a layer of porous, expanded polytetrafluoroethylene.

The two-part adhesive is applied to the tape with a die constructed of a sectioned, detachable housing, the housing sections having channels formed therein which define a flow passageway for the adhesive leading from two inlet ports, one inlet port for each part of the two-part adhesive, leading each part of the two-part adhesive from its respective supply into the flow passageway and therethrough within the die. The adhesive thence flows outwardly from the passageway and the die housing through at least one outlet and onto the tape. The outlet is positioned in close proximity to the tape and to the consolidation nip. Within the die, thorough mixing of the parts of the two-part adhesive is effected in the passageway during flow therethrough from the inlet ports to the outlet. Included with the die, within the housing, and in immediately adjacent proximity to the outlet, is a controllable on-off valve, synchronized in the process with the cutting of the tape so as to sequentially shut off the flow of the adhesive after the cutting of the tape such that adhesive just covers the severed tape, thereby completing one sealing operation. The mixing of the two parts of the adhesive is effected by a static mixer positioned within the passageway, the static mixer preferably having a vane helically oriented about a core to effect complete mixing. The static mixer element may be disposable upon detachment of the detachable housing, which housing may be detached following cutting of the tape and stopping the flow, and thereafter easily cleaned and fitted with a new static mixer.

The outlet from the die may be a narrow slit whose length is approximately the width of the tape or, preferably, the outlet may include a plurality of spaced apart capillary die openings linearly oriented in a direction transverse to the tape substantially across the entire width of the tape. In a preferred embodiment, each such capillary die has a diameter of 0.040 inch and a length of 0.063 inch.

The on-off valve preferably is a valve of the piston type, controllable, on or off, by a quarter-turn rotation of a valve stem.

This die itself may be suitable for other uses and, in its simplest form, includes a sectioned, detachable housing, the sections having channels formed therein which define a flow passageway extending from two or more inlet ports into the flow passageway and therethrough within the die to at least one outlet. The die includes mixing means within the passageway and a controllable on-off valve housed within the housing and in immediately adjacent proximity just upstream of the outlet. The mixing means may be a static mixer positioned within the passageway. If an adhesive system having three or more parts is used, it is clear to an artisan skilled in the art that more than two inlet ports can be incorporated in the die.

The die may be used in seam sealing processes other than that specified herein.

Liquid pumping apparatus is also provided including a gear pump driven by a stepper motor or a servo motor or the like. The intake of the gear pump is positioned within container means for the liquid adhesive component and within close proximity to the bottom of the container. Preferably the adhesive intake is positioned within one-quarter inch of the bottom of the container. An ultrasonic sensor continuously senses the level of the liquid in the container and shuts the system down at a preset, low liquid level, in order to prevent the system from running dry. These pumps are especially suited for delivering the two-part silicone adhesive as a sealer to seal seams according to the present invention.

### BRIEF DESCRIPTION OF THE DRAWINGS

In the accompanying drawings:

FIG. 1 is a perspective view of the apparatus for sealing seams in garments and the like according to the present invention;

FIG. 2 is a schematic perspective view of a seam sealing tape being applied to a seamed garment along the seam thereof;

FIG. 3 is a perspective view of the apparatus according to the invention illustrating the guiding and feeding of a sealing tape into the nip between a heated upper roller and a lower, belt-driven, opposing nip member, with the adhesive application die positioned adjacent the tape just prior to entry into the nip, showing the range of motion of the quill, the motion of the tape and the nip members, and the motion of the die, indicated by the arrows, all in the absence of a garment seam to be sealed for clarity of illustration.

FIG. 4 is a schematic diagram of a tape and a seamed garment entering the nip between a first heated roller and a lower, opposing belt member, which creates an extended nip length indicated by the bracket, just prior to entry of which the adhesive is shown being applied to the side of the tape facing the garment; exiting the extended nip is the seam sealed garment wherein the adhesive is at least partially cured;

FIG. 4A illustrates, in elevation, partly in cross-section, the juxtapositioning of the tape guide and adhesive die at the point of application of the adhesive to the tape.

FIG. 5 is an illustration similar to FIG. 4 but showing a shorter extended nip path length, also indicated by the bracket, which nip, depending on the operational speed of the nip-forming members, determines the residence time under curing conditions of the adhesive within the nip;

FIG. 6 illustrates tape and seamed garment being fed to a nip between an upper, heated, hard surfaced roller and a lower, soft-surfaced, covered opposing roller, also providing an extended nip, the adhesive being applied by the applicator die to the tape just prior to entry into the nip;

FIG. 7 is an exploded, perspective view of the adhesive applicator die according to the invention in its disassembled configuration, illustrating the various component parts of this die assembly;

FIG. 8 is a perspective view of the die assembly shown in FIG. 7 in its assembled configuration and including its controlled valve actuator;

FIG. 9 illustrates the process and apparatus according to the invention in operation effecting a seal to a seamed joint in a garment in one pass through the apparatus;

FIG. 10 illustrates a supply container reservoir for an adhesive component, including a metering pump, level sensor, pressure transducer and conveying line for supplying the adhesive to the die applicator of the invention;

FIG. 11 shows the reservoir and pump assembly of FIG. 10 partly broken away to illustrate the liquid adhesive component residing therein and the position of the pump intake.

### DETAILED DESCRIPTION OF THE INVENTION AND PREFERRED EMBODIMENTS WITH REFERENCE TO THE DRAWINGS

Apparatus and a method for sealing of seams in otherwise impermeable articles such as garments, footwear, surgical gowns and the like, are provided, the sealed seams maintaining the imperviousness of the garment, including the seamed joints, to water, body fluids, pathogens and chemicals. In one pass through the apparatus, a sealed seam in a protective barrier fabric joint, using a curable adhesive sealant, is provided along a predetermined and specified length of the joint. The preferred adhesive is a silicone, most preferably a two-part, thermosetting silicone elastomeric adhesive.

Also provided are mixing dies for use, inter alia, in the process which are especially suited for applying the two-part adhesive sealant. In addition, variable-residence-time curing apparatus, which effects variable, controlled, desired cures of the adhesive, all in a one-pass operation, is provided, together with precise metering pumps, especially suited for supplying the seam sealing adhesives in the process of the invention.

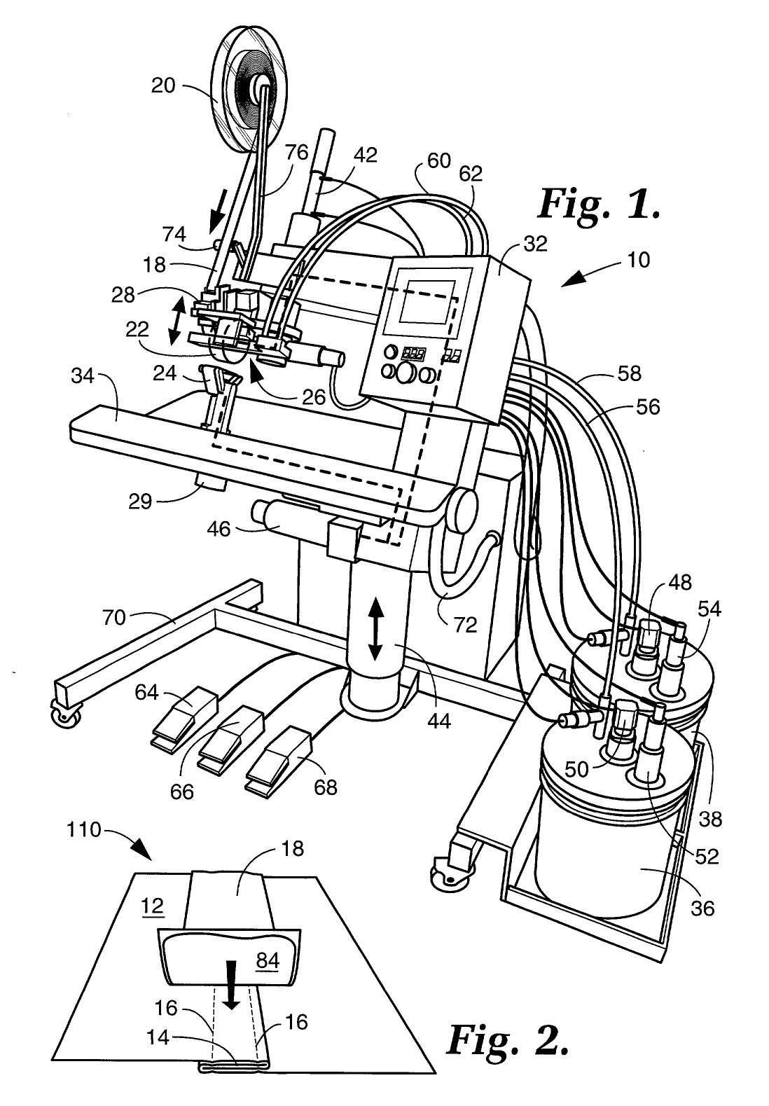

A detailed description of the invention and preferred embodiments is best provided with reference to the accompanying drawings, wherein FIG. 1 illustrates, in perspective, all of the various components of the apparatus 10 used to carry out seam sealing according to the invention. A garment whose seams are to be sealed is omitted from FIG. 1 for clarity of illustration.

In the figure, the apparatus 10 includes tape supply roll 20 mounted upon support bracket 76 from which backing tape 18 is withdrawn in the direction indicated by the arrow and fed to the tape guide 28, described in greater detail below. The tape 18 is thence guided to the nip between the upper nip roller 22 and the opposing, nip forming member 24, in the configuration shown being a belt 24 driven by pulleys. This assembly of tape roll 20, tape 18, tape feed and tape guide 28, and the upper roller 22, all as a unit termed herein the “quill”, is adjustable in space as indicated by the double-headed arrow, actuated by the actuator 42, the position during operation being set by the operator by a stop block incorporated into actuator 42. This entire upper assembly may be lowered according to predetermined settings to enable the roller 22 to contact the belt 24, displacing the belt 24, and providing a preset circumferential contact distance between the roller surface 22 and the belt 24. This circumferential contact distance, together with the speed of the tape, determines the residence time of the tape 18 within the nip as it passes therethrough.

Adhesive applicator die 26 is shown positioned in close proximity to the tape 18 at its entry point into the nip between roller 22 and belt 24, as shown. Adhesive is supplied to die 26 through supply lines 60 and 62, the volumetric flow therethrough being controlled at the control console 32 as indicated. The adhesive is supplied thereto from reservoirs 36 and 38. A two-component adhesive system is illustrated in FIG. 1, with each component being supplied from its respective supply reservoir as shown. The adhesive components are supplied to the die 26 from reservoirs 36 and 38 through respective supply lines 56 and 58, their flow being controlled as stated at the control console 32. Pumps 48 and 50, described fully below, meter the flow of the respective components of the two part adhesive, the volume of liquid remaining in each being monitored by respective ultrasonic sensors 52 and 54, one in each reservoir.

A working platform 34, on which is mounted the lower nip forming member 24, is also positionable up or down, as indicated by the double-headed arrow shown on the vertical telescoping post 44.

The various process functions, i.e. tape feed, adhesive feed through die 26, and tape cutting, are all controllable by the operator at will. They may be programmed to occur individually, sequentially or simultaneously, as will be evident to one skilled in the art. In FIG. 1, these controls are illustrated by foot pedals as shown, wherein, e.g., pedal 64 engages/disengages the positioning of the quill assembly and sets the roller 22 in contact at a preset position against belt 24, pedal 66 starts/stops the flow of the adhesive and starts/stops the nip roller 22 and the belt 24, and pedal 68 triggers the tape cutter, described below. Preferably the cutter pedal 68 is programmed to also arrest the flow of adhesive sequentially with the cutting of tape 18 such that adhesive is applied over the tape extending just to its cut length.

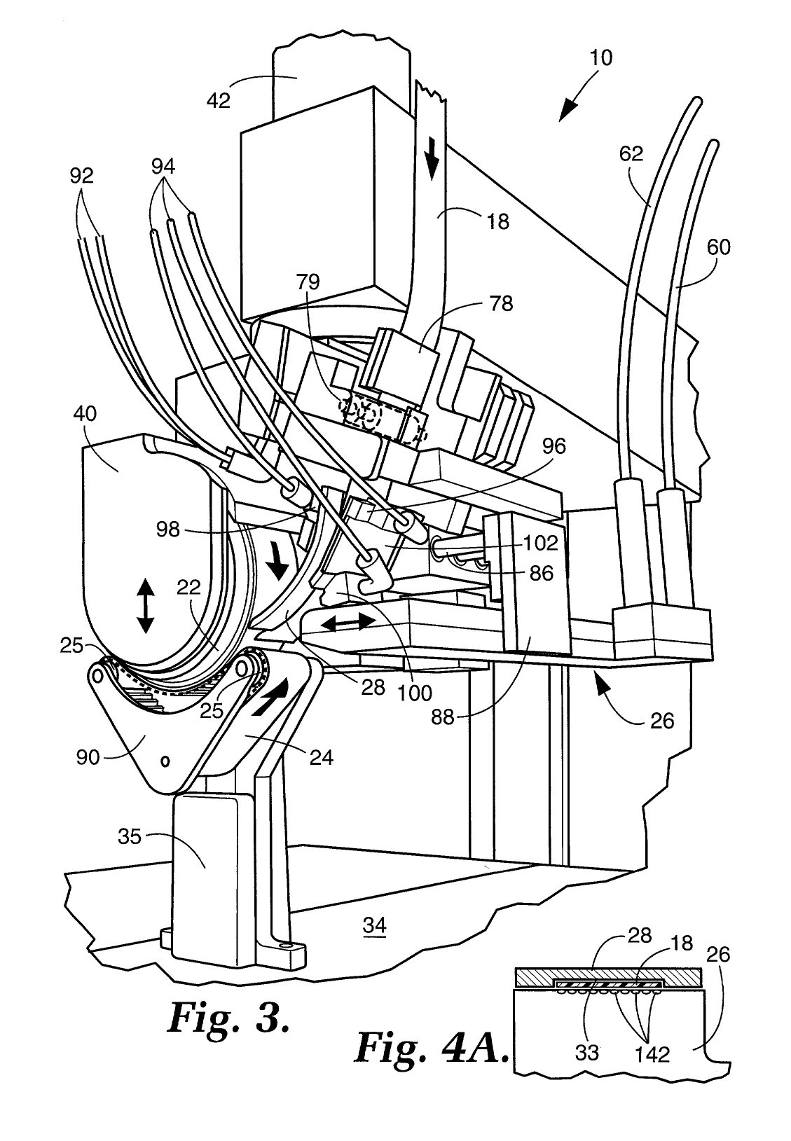

For completeness of FIG. 1, additional components illustrated include a castered support frame 70 which supports the entire apparatus, drive motor 46 for feeding tape 18, and electrical conduit 72 from the power supply, and other peripheral equipment and supports. The tape feeding, guiding, and cutting mechanisms are described in greater detail below with reference to FIG. 3.

FIG. 2 shows a schematic diagram of a stitch-seamed garment 12 being seam sealed with an adhesive 84 applied to a backing tape 18, the coated tape overlaying the stitching 16 and forming a bridge thereover, being adhesively bonded to the garment fabric 12. The resulting sealed construction 110 is completely impervious to unwanted liquid penetrants. Protective barrier garments, generally, contain at least two layers, a porous cover layer and the actual protective barrier layer. Rainwear, such as that sold under the trademark GORE-TEX®, employs microporous polytetrafluoroethylene as the protective barrier layer, and this material can be made by processes known in the art. See, e.g., U.S. Pat. Nos. 3,953,566 and 4,187,390. Cover layers can be selected to protect the barrier layer from abrasion, for aesthetic purposes or to provide further desired functionality in the garment. The bridging, sealing tape may comprise a similar construction. If such a two part sealing tape is used in the present invention, the adhesive is applied directly to the protective barrier layer of the tape, and then the tape is applied over the garment seam, with the adhesive side down contacting the seam.

The invention provides seals for many types of sewn seams, including, without limitation, simple seams, top stitched seams and felled seams. The seam 16, of FIG. 2, is normally a stitched seam, as sewing is universally employed worldwide in garment seaming.

FIG. 3 illustrates in greater detail the apparatus for feeding and guiding of the sealing tape 18 to the point of application to the garment seam. Here also, the garment and seam are omitted for clarity of illustration. Referring to FIG. 3, the backing tape 18, fed from roll 20, passes through the upper alignment guide 78 and thence downwardly between guide plate 102 and around curved guide plate 28, from which the tape 18 is fed into the nip between the upper roller 22 and, as shown, the lower, opposing nip-forming belt 24. The roller 22 is equipped with internal heaters described below, and is powered by motor 46 (see FIG. 1), this assembly of tape feed and guide mechanisms 78, 102 and 28, and driven roller 22, all being variably positionable vertically, indicated by the double headed arrow on heat shield 40, all positioned by actuator 42 at preset positions, which setting determines the curvature of the belt 24 and the concomitant circumferential contact distance between the belt 24 and the outer surface of the roll 22. The support 35, which supports the belt 24 riding on its idler rolls 25, and having guard 90, is affixed to the working platform 34, as shown. The belt 24 is preferably a belt made of a Kevlar reinforced silicone elastomer.

Backing tape 18 is fed into the system using metering rollers 19 described below, housed in housing 79, and, as it is guided through the guides 78, 102 and over the curved surface 28, the tape is further guided and motivated therethrough by non-contact means, preferably by air knives 96, 98, and 100, the latter imparting additional force for the tape 18 into the nip and ensuring that the tape 18 is precisely guided into the nip over and in contact with the surface of guide 28. Air is supplied to these knives through the supply lines 94.

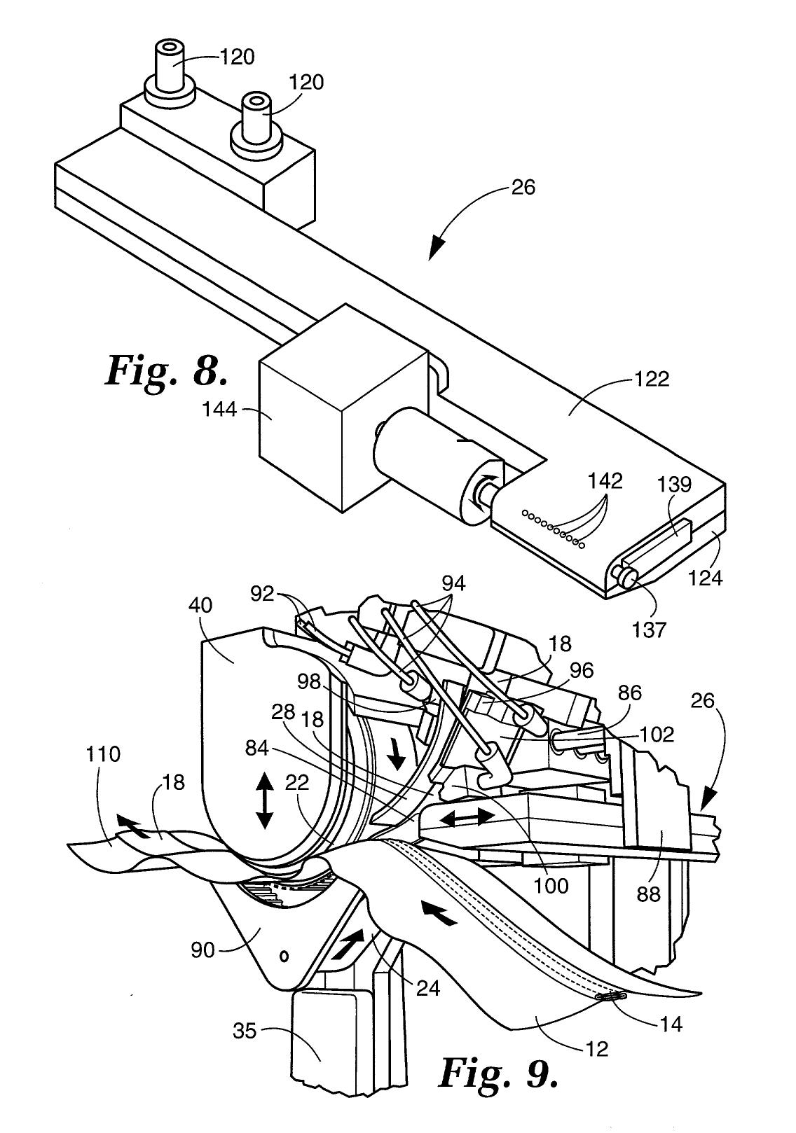

Tape cutter 30, described below but not visible in FIG. 3, is controlled from console 32 through connectors 92 and is preferably programmed to cut tape 18 simultaneously with the stoppage of adhesive flow from die 26. Die 26 is shown in FIG. 3 positioned immediately adjacent the nip into which tape and garment seam are fed. Its details are described with reference to FIGS. 7 and 8 below. Here it can be seen that this die 26 is variably positionable in space by means of actuators 86 connected by bracket 88, the available movement horizontally of die 26 indicated by the double headed arrow shown on the end of this die. Also not visible in FIG. 3 are the outlets from die 26 through which the adhesive flows onto tape 18. Feed lines 60 and 62 supply the components of a two-part adhesive to die 26.

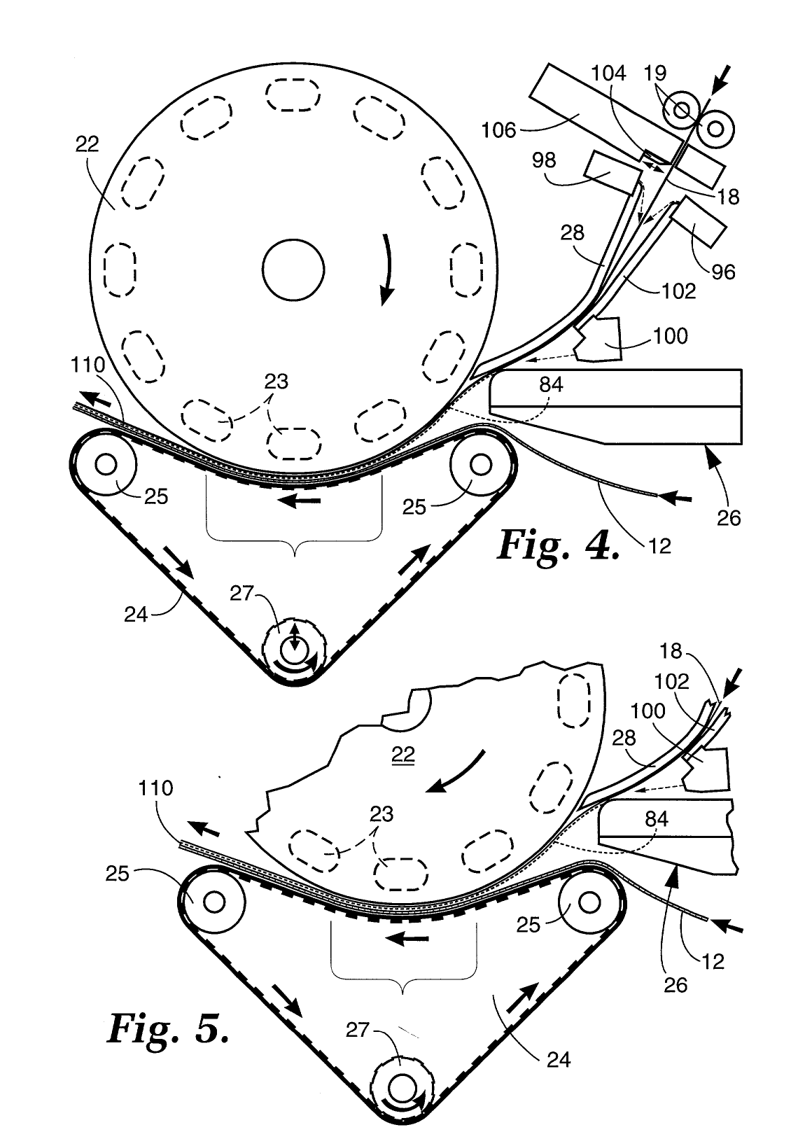

FIG. 4 is a schematic representation of one mode of sealing the seam of a garment according to the invention. Therein, garment 12 (see FIG. 2) with seam 16 is fed into the nip formed between upper roller 22 and lower, endless belt 24 rides on idler pulleys 25 and may itself be driven by drive roll 27, all progressing in the directions of the arrows shown. The upper quill assembly has been positioned to provide the preset contact distance, indicated by the bracket, between the roller 22 and the belt 24 along the circumference of the roll 22. The roll 22 has built in, controllable heaters 23 which control the heat provided within the nip zone.

Adjacent the seamed garment 12 is fed the backing tape 18, metered thereto by cooperating rollers 19, initially passing through cutting actuator 106 having cutting blade 104, and thence between guide surfaces 102 and 28, motivated therethrough by the action of air knives 96 and 98, with knife 100 providing non-contact means for forcing the tape 18 against curved guide plate 28 and guiding it into the nip. When initially feeding tape 18, these air knives 96, 98 and 100 cooperate to permit threading of the tape 18 into the system, all in a hands-free operation. Immediately upstream from the nip is the die 26 from which the adhesive 84 flows and is applied to the surface of the backing tape 18 just before it enters the nip. This applied adhesive cures, at least partially, within the nip as a result of the heating therein and the applied pressure of the belt 24 pressing against the roll 22 within the extended nip (bracketed).

FIG. 4A illustrates, in elevation, the juxtaposition of guide 28 with die 26 at the point of application of the adhesive to the tape 18. The tape 18 is threaded into and is guided within channel 33, which channel 33, as shown, permits abutment of the die 26 with the guide 28 thereat, and thereby provides precise guidance of the tape as it passes over the adhesive application point, in the figure shown being capillary ports 142, described below in further detail.

FIG. 5 shows an alternate embodiment similar to that of FIG. 4. Therein, the tape 18 and seamed garment 12 are processed through the nip as before, but the upper quill assembly is raised slightly, resulting in a shorter circumferential contact path within the nip between the roller 22 and the belt 24, all indicated by the shorter bracket, as compared to FIG. 4. It is clear that variations in this path length at given spacings, i.e., the extended nip length, could also be achieved by using belts of differing elasticity and by varying the tension on a given belt, i.e., by increasing the distance between the upper nip roll 22 and the lower driving roll 27 depicted in FIG. 5. In all other respects, FIG. 5 and FIG. 4 are the same.

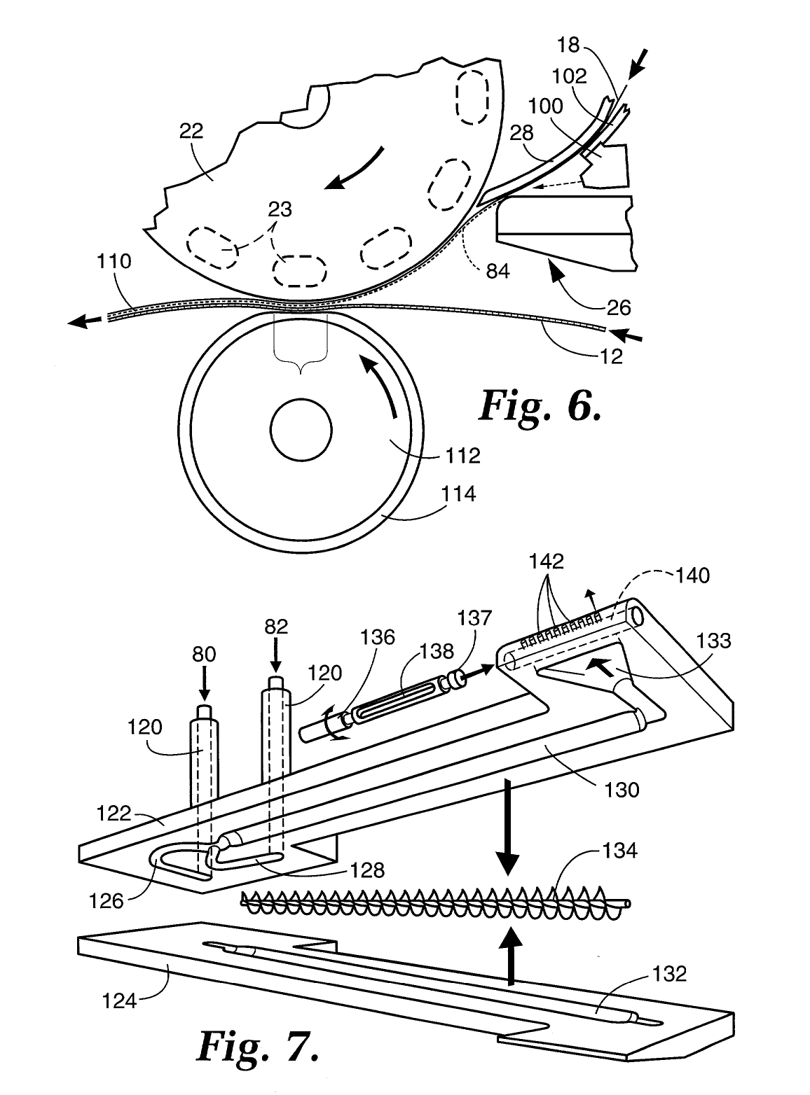

In a still further nip roll embodiment, FIG. 6 illustrates a hard-surfaced, internally heated upper roll 22 opposing a lower, nip forming roll 112 on whose surface is affixed a relatively soft covering 114, of, for example, a foam material, such as a silicone foam. Use of this soft-surfaced roll 112 will also provide an extended nip and thereby increase the residence time under pressure of the curing adhesive 84 applied between the tape 18 and the garment 12 as it passes between rollers 22 and 112.

The actual pressure within the nip, when a belt 24 is employed, is determined by the belt tension. The belt is tensioned by pulley 27 (which is also the drive pulley) which is actuated by air actuator 29 positioned under the table surface 34. The resulting nip pressure is actually much less than would be imparted by actuator 42 alone. In the case of a deformable roller, the nip pressure is dictated by actuator 42.

Die 26, shown in detail in FIGS. 7 and 8, is especially suited to application of the two-part silicone adhesive in the process of the invention. Die 26 comprises two separable sections 122 and 124, which may be attached together by means of screws or the like, not shown. This die is preferably made from stainless steel or other non-corrosive metal. The upper half-section 122 of the die has inlet ports 120, each receiving one part of the liquid, two-part adhesive through the respective adhesive supply lines 80 and 82. Channels 126 and 128 in upper section 122 lead from the inlet ports to a main upper channel 130, which extends through the length of the die body as shown to a distributor channel 133 leading to the valved outlets 142. The outlets 142 are shown in this embodiment as capillary openings, but, in another embodiment, a single slit opening is employed. The plurality of capillary openings is preferred and, for the adhesive system discussed below, capillaries each having a diameter of 0.040 inch and length of 0.063 inch are preferred.

The lower half-section 124 of die 26 has channel 132 machined therein as shown such that, when the die is assembled, the channels 130 and 132 register with one another to form a central passageway through which the adhesive flows and into which, prior to assembly, a mixing device 134, preferably a static mixer, is placed. This mixer is preferably an inexpensive mixing device, disposable after each use, and a device such as a Statomix® MC10-18, manufactured by ConProTec, Inc., is suitable for this purpose.

The outlets 142 from the die 26 are valved, preferably by the piston valve 136 depicted. The valve 136 comprises the elongate piston having slit 138 therethrough and head 137 located at its outboard end. This piston valve 136 inserts into bore 140 in upper die section 122 and extends through the bore and outwardly therefrom as shown in FIG. 8. Referring to FIG. 7, it is seen that a quarter turn of the valve stem, indicated by the double-headed arrow, controls the adhesive flow, on or off, through the outlets 142.

In FIG. 8, the assembled die 26, together with controlled actuator 144, is shown in perspective, including inlet ports 120, body sections 122 and 124 and capillary outlets, ten in number, 142. The valve stem 136 is kept in place by key mechanism 139.

FIG. 9 illustrates the complete operation of the assembled apparatus. Therein, seamed garment 12 is fed (by an operator) into the nip between heated roll 22 and the endless belt 24. The tape 18 is fed to and guided into the nip by air knife 100 through guides 102 and 28, whereat the adhesive 84 is applied from die 26. On passage through the nip, the adhesive 84 is at least partially cured under the applied heat and pressure from roll 22 to form the seam sealed garment 110, all according to the invention. Cutting of the tape and cessation of adhesive flow are controlled and triggered by the action of the operator pressing upon foot pedal 68 (FIG. 1), which, in sequence, cuts the tape and then arrests the adhesive flow such that adhesive just covers the severed tape and not beyond, thereby avoiding unnecessary and messy spillage.

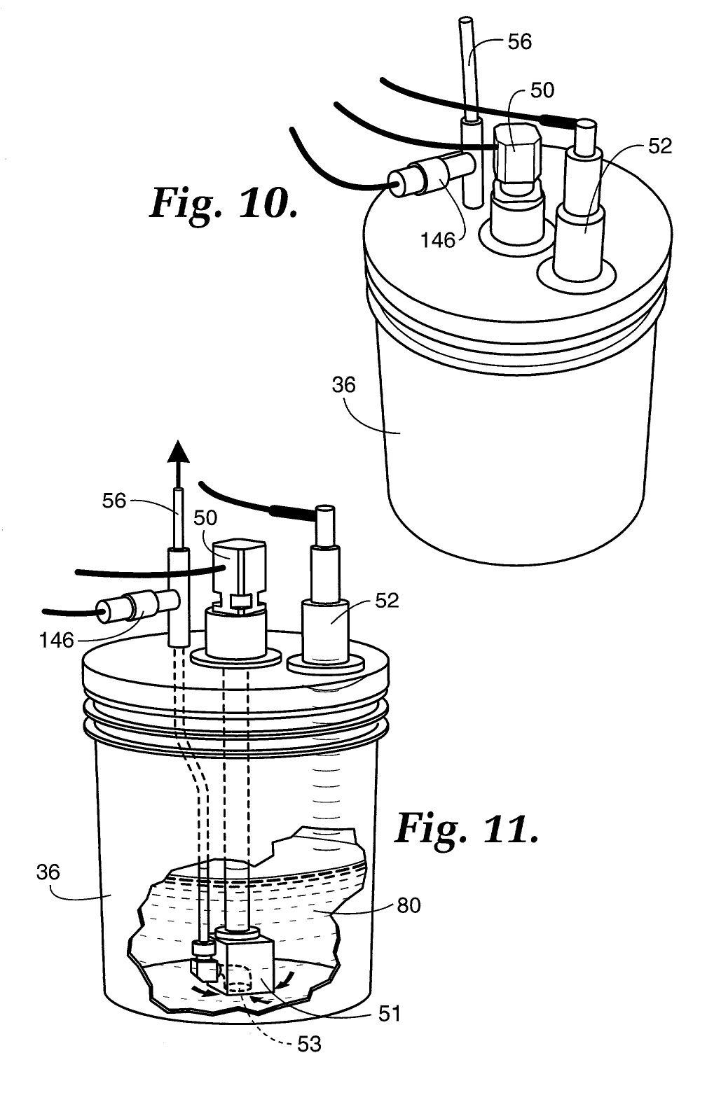

FIG. 10 shows a supply reservoir 36 (container, pail, tub) for holding the supply of a liquid adhesive therein. If a two-part curable adhesive is employed, then two reservoirs, such as reservoirs 36 and 38 shown in FIG. 1, are used, and both may be identical, and both may be plastic pails. Stepper motor 50 meters the flow of the adhesive component to the system through supply line 56. Pressure transducer 146 is set to shut the system down if a preset maximum pressure is sensed, to avoid catastrophic failure. Ultrasonic level sensor 52 is set to stop motor 50 if a low adhesive level is detected.

FIG. 11 shows the reservoir 36 partially broken away to illustrate the motor 50 powering pump 51 having intake 53 positioned, as shown, in close proximity to the bottom of reservoir 36 and into which adhesive component 80 is sucked, and thereafter flows through supply line 56 to the sealing apparatus, as indicated by the arrow. The distance between the intake 53 and the bottom of the pail 36 is preferably less than one-half inch, and most preferably does not exceed one-quarter inch. The ultrasonic sensor 52 (note the sound waves impinging on the surface of the adhesive 80) senses the level of the adhesive in the reservoir and shuts the system down when a preset, low level of adhesive component 80 is detected.

For reference purposes, the preferred adhesive system employed in the process of this invention is a two-part silicone adhesive system marketed by W. L. Gore & Associates, Inc., Elkton, Md., under the product designation GORE-BOND SL1.

While the invention has been disclosed herein in connection with certain embodiments and detailed descriptions, it will be clear to one skilled in the art that modifications or variations of such details can be made without deviating from the gist of this invention, and such modifications or variations are considered to be within the scope of the claims hereinbelow.

What is claimed is:

1. A method for sealing seams in protective barrier fabrics such as garments and the like, including, in one continuous operation:
(a) feeding the seamed joint of a protective barrier fabric along the length thereof to and through a consolidation nip,
(b) simultaneously feeding and guiding a backing tape to and through said nip adjacent said seamed joint,
(c) applying at a metered rate a curable sealing adhesive along a length of said tape just prior to entry of the tape into the nip, the adhesive being applied to that surface of the tape facing the seamed joint,
(d) consolidating said tape with applied sealing adhesive thereon and the seamed joint of said fabric in the nip while guiding the tape such that it lies along the length of and covers the seam, the sealing adhesive contacting the joint,
(e) at least partially curing the adhesive with applied heat and pressure during passage through the nip, and
(f) cutting the tape to a specified length and, sequentially, stopping application of the sealing adhesive such that the adhesive extends over the cut length of tape but not beyond,
thereby completing sealing the seam to the desired length along said seamed joint.

2. The method of claim 1 wherein said adhesive is a silicone adhesive.

3. The method of claim 1 wherein said adhesive is a multi-part adhesive.

4. The method of claim 3 wherein said adhesive is a two-part silicone adhesive.

5. The method of claim 1 wherein said consolidation nip is formed between a first member, being a roller member, and a second, co-acting, nip-forming member.

6. The method of claim 5 wherein said first roller member is heated.

7. The method of claim 5 wherein said second, nip-forming member is a roller.

8. The method of claim 5 wherein said first roller member and said second, co-acting, nip-forming member are substantially vertically oriented, one with respect to the other.

9. The method of claim 5 wherein the distance between said first member and said second, co-acting member is adjustable.

10. The method of claim 9 wherein said second, nip-forming member is a roller having a compressible surface thereof.

11. The method of claim 9 wherein said second, nip-forming member comprises an endless belt.

12. The method of claim 11 wherein said endless belt and said first roller member are adjustable in space, one with respect to the other, so as to enable variation of the contact distance of said belt with said first roller circumferentially along the first roller and within said nip, and adjusting said belt with respect to said first roller to effect a preset contact distance therebetween.

13. The method of claim 12 wherein said contact distance is from about 0.5 inch to about 6 inches.

14. The method of claim 11 including applying tension to said endless belt in order to apply compressive pressure within said nip and between said tape and said joint.

15. The method of claim 1 wherein the guiding of said backing tape is assisted using non-contact means.

16. The method of claim 15 wherein the guiding of said backing tape is assisted with air knives.

17. The method of claim 15 wherein the tape guiding is assisted using applied vacuum.

18. The method of claim 1 wherein said protective barrier fabric comprises a laminate of a backing fabric and a layer of microporous material.

19. The method of claim 18 wherein said microporous material is a material selected from the class consisting of microporous polytetrafluoroethylene, microporous polypropylene, microporous polyurethane and microporous polyetherpolyester.

20. The method of claim 18 wherein said microporous material is porous, expanded polytetrafluoroethylene.

21. The method of claim 1 wherein said backing tape is a composite tape comprising a laminate of a backing fabric and a layer of a microporous material.

22. The method of claim 21 wherein said microporous material is a material selected from the class consisting of microporous polytetrafluoroethylene, microporous polypropylene, microporous polyurethane and microporous polyetherpolyester.

23. The method of claim 21 wherein said microporous material is porous, expanded polytetrafluoroethylene.

24. The method of claim 1 wherein said protective barrier fabric comprises a laminate of a backing fabric and a layer of porous, expanded polytetrafluoroethylene, and wherein said backing tape is a composite tape comprising a laminate of a backing fabric and a layer of porous, expanded polytetrafluoroethylene.

25. The method of claim 3 wherein said multi-part adhesive is applied to said tape through a die comprising:
(a) a sectioned, detachable housing, said sections having channels formed therein which define a flow passageway for said adhesive from
(b) at least two inlet ports, one inlet port for each part of said multi-part adhesive, leading each part of the multi-part adhesive from its respective supply into said flow passageway and therethrough within said die, the adhesive thence flowing outwardly from said passageway and said die housing through
(c) at least one outlet and onto said tape, said outlet being positioned in close proximity to said tape and to said consolidation nip, wherein,
(d) thorough mixing of the parts of the multi-part adhesive is effected within said passageway during flow therethrough from said inlet ports to said outlet, said die including, within said housing and in immediately adjacent proximity to said outlet,
(e) a controllable on-off valve.

26. The method of claim 25 wherein said mixing is effected by a static mixer positioned within said passageway.

27. The method of claim 26 wherein said static mixer has a vane helically oriented about a core to effect said mixing.

28. The method of claim 26 wherein said static mixer is disposable upon detachment of the detachable housing.

29. The method of claim 25 including detaching said detachable housing following cutting of said tape and stopping said flow, and thereafter cleaning said housing sections.

30. The method of claim 25 wherein said at least one outlet is a narrow slit whose length is approximately the width of said tape.

31. The method of claim 25 wherein said at least one outlet comprises a plurality of spaced apart capillary die openings linearly oriented in a direction transverse to said tape substantially across the entire width of said tape.

32. The method of claim 31 wherein each capillary die has a diameter of 0.040 inch and a length of 0.063 inch.

33. The method of claim 25 wherein said on-off valve is a valve of the piston type, controllable, on or off, by a quarter-turn rotation of a valve stem.

34. The method of claim 1 wherein said curable sealing adhesive is supplied from a container, said container equipped with a pump driven by a controlled motor and an ultrasonic level sensor, wherein the intake of said pump is positioned in close proximity to the bottom of said container, and stopping the motor when said sensor senses that the adhesive has reached a preset level.

35. Apparatus for sealing seams in protective barrier fabrics such as garments and the like, including:
(a) means for feeding the seamed joint of a protective barrier fabric along the length thereof to and through a consolidation nip,
(b) means for simultaneously feeding and guiding a backing tape to and through said nip adjacent said seamed joint,
(c) means for applying, at a metered rate a curable sealing adhesive along a length of said tape just prior to entry of the tape into said nip, the adhesive being applied to that surface of the tape facing the seamed joint,
(d) means for consolidating said tape with applied sealing adhesive thereon and the seamed joint of said fabric in the nip, including means for guiding the tape such that it lies along the length of and covers the seam, the sealing adhesive contacting the joint,
(e) means for at least partially curing the adhesive with applied heat and pressure during passage through the nip, and
(f) means for cutting the tape to a specified length and, sequentially, stopping application of the sealing adhesive.

36. The apparatus of claim 35 wherein said adhesive is a silicone adhesive.

37. The apparatus of claim 35 wherein said adhesive is a multi-part adhesive.

38. The apparatus of claim 37 wherein said adhesive is a two-part silicone adhesive.

39. The apparatus of claim 35 wherein said consolidation nip is formed between a first member, being a roller member, and a second, co-acting, nip-forming member.

40. The apparatus of claim 39 wherein said first roller member is heated.

41. The apparatus of claim 39 wherein said second, nip-forming member is a roller.

42. The apparatus of claim 39 wherein said first roller member and said second, co-acting, nip-forming member are substantially vertically oriented, one with respect to the other.

43. The apparatus of claim 39 wherein the distance between said first member and said second, co-acting member is adjustable.

44. The apparatus of claim 43 wherein said second, nip-forming member is a roller having a compressible surface thereof.

45. The apparatus of claim 43 wherein said second, nip-forming member comprises an endless belt.

46. The apparatus of claim 45 including means for adjusting said first roller member and said second belt member in space, one with respect to the other, so as to enable variation of the contact distance of said belt with said first roller circumferentially along the first roller and within said nip.

47. The apparatus of claim 46 wherein said contact distance is from about 0.5 inch to about 6 inches.

48. The apparatus of claim 45 including means for applying tension to said endless belt in order to apply compressive pressure within said nip and between said tape and said joint.

49. The apparatus of claim 35 wherein the means for guiding of said backing tape includes non-contact means.

50. The apparatus of claim 49 wherein the non-contact means are air knives.

51. The apparatus of claim 49 wherein the tape guiding means includes applied vacuum means.

52. The apparatus of claim 35 wherein said protective barrier fabric comprises a laminate of a backing fabric and a layer of microporous material.

53. The apparatus of claim 52 wherein said microporous material is a material selected from the class consisting of microporous polytetrafluoroethylene, microporous polypropylene, microporous polyurethane and microporous polyetherpolyester.

54. The apparatus of claim 52 wherein said microporous material is porous, expanded polytetrafluoroethylene.

55. The apparatus of claim 35 wherein said backing tape is a composite tape comprising a laminate of a backing fabric and a layer of a microporous material.

56. The apparatus of claim 55 wherein said microporous material is a material selected from the class consisting of microporous polytetrafluoroethylene, microporous polypropylene, microporous polyurethane and microporous polyetherpolyester.

57. The apparatus of claim 55 wherein said microporous material is porous, expanded polytetrafluoroethylene.

58. The apparatus of claim 35 wherein said protective barrier fabric comprises a laminate of a backing fabric and a layer of porous, expanded polytetrafluoroethylene, and wherein said backing tape is a composite tape comprising a laminate of a backing fabric and a layer of porous, expanded polytetrafluoroethylene.

59. The apparatus of claim 37 including means for applying said multi-part adhesive to said tape through a die comprising:
(a) a sectioned, detachable housing, said sections having channels formed therein which define a flow passageway for said adhesive extending from
(b) at least two inlet ports, one inlet port for each part of said multi-part adhesive, leading each part of the two-part adhesive from its respective supply into said flow passageway and therethrough within said die to
(c) at least one outlet through which the adhesive may flow outwardly from the die and onto said tape, wherein said die includes
(d) mixing means within said passageway and
(e) a controllable on-off valve housed within said housing and in immediately adjacent proximity upstream of said outlet.

60. The apparatus of claim 59 wherein said mixing means includes a static mixer positioned within said passageway.

61. The apparatus of claim 60 wherein said static mixer has a vane helically oriented about a core to effect thorough mixing.

62. The apparatus of claim 60 wherein said static mixer is removable from said housing and, upon detachment of the detachable housing, is disposable.

63. The apparatus of claim 59 wherein said at least one outlet is a narrow slit whose length is approximately the width of said tape.

64. The apparatus of claim 59 wherein said at least one outlet comprises a plurality of spaced apart capillary die openings linearly oriented in a direction transverse to said tape and extending substantially across the entire width of said tape.

65. The apparatus of claim 64 wherein each capillary die opening has a diameter of 0.040 inch and a length of 0.063 inch.

66. The apparatus of claim 59 wherein said on-off valve is a valve of the piston type, controllable, on or off, by a quarter-turn rotation of a valve stem.

67. The apparatus of claim 35 including means for supplying said curable sealing adhesive from a container by means of a pump driven by a controlled motor, said container equipped with an ultrasonic level sensor, wherein the intake of the pump is positioned in close proximity to the bottom of said container.

68. A die comprising:
(a) a sectioned, detachable housing, said sections having channels formed therein which define a flow passageway extending from
(b) at least two inlet ports into said flow passageway and therethrough within said die to
(c) at least one outlet, wherein said die includes
(d) mixing means within said passageway and
(e) a controllable on-off valve housed within said housing and in immediately adjacent proximity upstream of said outlet.

69. The die of claim 68 wherein said mixing means includes a static mixer positioned within said passageway.

70. The die of claim 69 wherein said static mixer has a vane helically oriented about a core to effect thorough mixing.

71. The die of claim 69 wherein said static mixer is removable from said housing and, upon detachment of the detachable housing, is disposable.

72. The die of claim 68 wherein said at least one outlet is a narrow slit.

73. The die of claim 68 wherein said at least one outlet comprises a plurality of spaced apart, linearly oriented capillary die openings.

74. The die of claim 73 wherein each capillary die opening has a diameter of 0.040 inch and a length of 0.063 inch.

75. The die of claim 68 wherein said on-off valve is a valve of the piston type, controllable, on or off, by a quarter-turn rotation of a valve stem.

76. In seam sealing apparatus, an adhesive applicator die comprising:
(a) a sectioned, detachable housing, said sections having channels formed therein which define a flow passageway extending from
(b) two inlet ports into said flow passageway and therethrough within said die to
(c) at least one outlet, wherein said die includes
(d) mixing means within said passageway and
(e) a controllable on-off valve housed within said housing and in immediately adjacent proximity upstream of said outlet.

77. The apparatus of claim 76 wherein said mixing means includes a static mixer positioned within said passageway.

78. The apparatus of claim 77 wherein said static mixer has a vane helically oriented about a core to effect thorough mixing.

79. The apparatus of claim 77 wherein said static mixer is removable from said housing and, upon detachment of the detachable housing, is disposable.

80. The apparatus of claim 77 wherein said at least one outlet is a narrow slit.

81. The apparatus of claim 77 wherein said at least one outlet comprises a plurality of spaced apart, linearly oriented capillary die openings.

82. The apparatus of claim 81 wherein each capillary die opening has a diameter of 0.040 inch and a length of 0.063 inch.

83. The apparatus of claim 77 wherein said on-off valve is a valve of the piston type, controllable, on or off, by a quarter-turn rotation of a valve stem.

84. Liquid pumping apparatus comprising a pump driven by a controlled motor, said pump having an intake submersed in a liquid within a container, wherein the intake of the pump is positioned within said container in close proximity to the bottom of said container, the apparatus including an ultrasonic level sensor for continuously sensing the level of the liquid in said container.

85. The apparatus of claim 84 wherein said intake is positioned within one-quarter inch of the bottom of said container.

86. Apparatus for sealing seams in protective barrier fabrics such as garments and the like, including:
(a) a consolidation nip into which may be fed the seamed joint of a protective barrier fabric along the length thereof, the consolidation nip formed between a first member, being a roller member, and a second, co-acting nip-forming member, and having
(b) cooperating rollers for feeding a backing tape to and through said consolidation nip adjacent said seamed joint,
(c) a die for applying, at a metered rate, a curable multi-part sealing adhesive along a length of said tape just prior to entry of the tape into said nip, the adhesive applied to that surface of the tape facing the seamed joint, and also having
(d) a channeled guide positioned immediately adjacent said die, to and through which channel is fed said tape, exiting therefrom just prior to being fed to said nip, and
(e) heaters imbedded within said first roller for at least partially curing the adhesive under applied heat and pressure during passage through said nip, and
(f) a cutter acting cooperatively and sequentially with an on-off valve in said die such that the tape, upon passage to and through said nip, is cut and adhesive is applied extending over the cut length of tape but not beyond.

87. The apparatus of claim 86 wherein said second, nip-forming member is an endless belt.

88. The apparatus of claim 86 wherein said second, nip-forming member is a roller having a compressible surface thereof.
